(19) United States
(12) Patent Application Publication
(10) Pub. No.: US 2023/0245192 A1
(43) Pub. Date: Aug. 3, 2023

(54) SYSTEM, METHOD AND APPARATUS FOR AUGMENTING RELAITY WITH TRUE-TO- SIZE APPAREL

(71) Applicant: Loko AI, Inc., Irvine, CA (US)

(72) Inventors: Joseph Zaki, Irvine, CA (US); Ehsan Adeli, Menlo Park, CA (US)

(21) Appl. No.: 17/591,328

(22) Filed: Feb. 2, 2022

(51) Int. Cl. G06Q 30/06; G06Q 10/08; G06T 15/20; G06T 17/20; G06T 19/20; G06T 19/00; G06V 20/20; G06V 40/10; G06V 40/20

(52) U.S. Cl. CPC G06Q 30/0621; G06Q 30/0643; G06Q 10/087; G06T 15/205; G06T 17/20; G06T 19/20; G06T 19/006; G06V 20/20; G06V 40/10; G06V 40/20; G06T 2215/16; G06T 2219/2021

(57) ABSTRACT

A system, method, and apparatus for augmenting reality with true-to-size apparel and even accessories is provided. Such system, method, and apparatus may be performed by or at a personal electronic device such as a smartphone. The personal electronic device may be configured to capture and display in real time, as desired, a scene containing at least a portion of a targeted body and identify plurality of keypoints such as joints, features, and outlines, on such body. The personal electronic device may be further configured to generate a three-dimensional mesh of the body and correlate keypoints of three-dimensionally rendered clothing and accessories with the body keypo its. The size of such body and clothing and accessories may be accurately digitally displayed relative to one another. The three-dimensionally rendered clothing and accessories may track any movements of the three-dimensional mesh of the body such that the digitally displayed and three-dimensionally rendered clothing and accessories appear to augment the body as if being worn.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPY & TRADEMARK NOTICES

A portion of the disclosure of this patent document may contain material which is subject to copyright protection. This patent document play show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject natter relates generally to fashion and garment fitting, and more particularly, to systems and methods that digitally augment a user's body with digital renderings of certain goods according to the user's individual dimensions and surface contours.

### BACKGROUND

In the digital age, consumers are making more of their purchases online. Fashion purchases have led this surge, with market research and sonsumer data analysis from Statista projecting a market share of $1,164 billion by 2025. Unfortunately, clothing and footwear are also the top items returned by consumers. This is usually because of incorrect size. These returns are preventable, with some sources claiming that fifty-six percent of consumers report their returns are the result of ordering several sizes and then returning those that don't fit after trying their orders on at home.

To address these issues, some ecommerce sites have attempted to offer consumers opportunities to virtually “try on” an item utilizing a variety of methods. For example, U.S. Pat. No. 9,905,019 to Applegate, requires the user to input their personal measurements, a picture of themselves, or a combination of photos and measurements to determine how the clothes would fit them. This proposal is deficient as it relics on the consumer's self-reported measurements to operate. This, of course, renders the proposals vulnerable to human error, as, for instance, the consumer is not prevented from providing measurements that are potentially inaccurate on account of imprecise measuring technique or from a failure to properly remember or guess their current measurements.

Other proposals, such as U.S. Pat. No. 6,546,309 to Gazuollo and U.S. Pub. No, 2018/0137515 teach the use of special tools, such as a full body scanner, to determine the consumer's measurements to inform the virtual “try on.” These proposals are deficient, however, because they require the consumer to maintain access to the specialized tools when their appearance changes such as following weight gain or loss.

Additionally, clothes fall differently on individual, unique bodies. That is, fabric is known to drape or stretch over different areas of one's body differently depending on such features as weight and/or fat distribution, posture, asymmetries, and others. Unfortunately, current virtual fitting rooms, such as the fitting room referenced in Applegate, above, are unable to accurately take these idiosyncrasies into account. In particular, many simply directly align points of reference on a photograph of a listed apparel to corresponding points on a user's uploaded image, which results in the article of clothing appearing and draping as it did in the reference photo. This, of course, renders the resulting image likely inaccurate across different body shapes.

In addition to the foregoing, the availability of personal computing systems has given rise to virtual communities in which users enjoy many opportunities to express their individuality. In virtual reality and augmented—or mixed reality—systems, in particular, it may be possible to digitally alter one's own appearance in a realistic way. For instance, U.S. Pat. No. 7,612,794 to Li-wei One proposes digitally augmenting reality according one's personal tastes and interests by way of a digital background in videoconferencing rendered to obscure one's real-life surroundings. This proposal also teaches applying a smoothing feature to the skin to remove imperfections. This is deficient, however, for two reasons. First, the background feature is static. It does not take into consideration movement and thus fails to contemplate the possibility of a user from digitally interacting with their augmenting surroundings. Additionally, the smoothing feature adjusts pixels already present in the image. That is, it only teaches altering existing features rather than augmenting such features with additional material.

Thus, although various proposals have been made to both avoid unnecessary merchandise returns and even recreationally, digitally alter one's appearance, none of those in existence combine the characteristics of the present invention. Therefore, there remains a need digital systems that Thus, there remains a need for a readily available interface where users can, without any additional equipment, see a dynamic depiction of how an article of clothing would accurately look on their body is necessary.

### SUMMARY

The present disclosure is directed to systems and methods operative to digitally augment a user's body with digital renderings of certain goods according to the user's individual dimensions and any gradient defining the user's surface contours. It is contemplated that providing a system, method, and apparatus for augmenting reality with true-to-size apparel according to the disclosure and claims provided below may beneficially enable digital methods of personal expression as well as more accurately inform remote purchasing decisions.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system comprises a personal electronic device, such as a smartphone, laptop, desktop, or even tablet computer. In any case, such personal electronic device will comprise an integrated or auxiliary means for capturing images and/or video, or “content,” and further recording and displaying such content from recordings and/or in real. In some embodiments, means for capturing content will be a camera integrated into the device, such as a smartphone camera. It is contemplated, however, that auxiliary cameras configured to electronically communicate with the personal electronic device by way of a universal serial bus or other connector or some wireless means such as Bluetooth or Wi-Fi may also satisfy the invention. In some embodiments, content may be displayed by the personal electronic device without any need of also recording or otherwise storing such content. That is, a camera can be configured to digitally and two-dimensionally display people, items, and scenes in real time as desired. For the sake of brevity only and not limitation, this disclosure may refer to the personal electronic device as a smartphone, such as any of those having an integrated camera, however, it will be understood that the system, method, and apparatus for augmenting reality with true-to-size apparel, accessories, and any other desirable goods may be enabled by many personal electronic device and image capture device combinations.

The smartphone, or other personal electronic device, as the case may be, may be further operative to generate a three-dimensional (“3D”) mesh of a user from two-dimensional (“2D”) content captured by its integrated or auxiliary camera. The 3D mesh may be generated from content as a single photo, multiple photos, a video or even a live content feed. To that end, in one embodiment, the electronic device way be particularly operative to identify a plurality of predefined keypoints on a targeted subject of the camera. In some embodiments, the target may be one or more of the user's body parts, such as a head, foot (or feet), hand(s), neck, torso, back, arm(s), leg(s), digit(s), and face, as non-limiting examples, and combinations of the same. In some embodiments, the target may be another individual, or group of individuals, or even an animal, or any of the body parts or physical aspects of the, foregoing possible targets. Keypoints may comprise one or more joints, such as shoulders, elbows, wrists, hips, knees, and/or ankles, and/or any other feature on a body, such as an outline of the body or body part, head, neck, ears, chin, any of the various facial features, hair, or any other point of reference as may be discerned on a body. Once identified by the system, the system may further triangulate the keypoints in three dimensions to produce a 3D mesh representing the target's dimensions and any surface contours. In some embodiments, the smartphone or other personal electronic device, and in particular, its camera, may comprise means for measuring distances between key points in three dimensions. That is, the system may be configured to triangulate keypoints in three dimensions in order to reflect depth as necessary to accurately represent a target's surface contours.

Some smartphones and personal electronic devices configured to capture or display two-dimensional renderings of targeted objects or individuals in a scene comprise means for measuring a camera target that arc operative to determine not only the target's relative height and width as compared with its surroundings, but also absolute height and width, as well as any depth or gradient in the target's surface contours. In some embodiments, means for measuring a camera target comprise at least one depth scanner. In some embodiments, the depth scanner may comprise a light detection and ranging (“LiDAR”) scanner. In such embodiments, the depth scanner may be operative to target objects with a laser and measure the time for the laser to return to the sensor once reflected from the target. In such cases, depth will be correlated with the difference in the amount of time it takes the laser to reflect from portions of a targeted surface. In some embodiments, the depth scanner may be configured to identify the distance of any targeted surface, such as an outer surface of a targeted individual's body, including any clothing or coverings, within about 10 feet, within about 20 feet, or even more, of the sensor.

In some embodiments, the system may be configured to receive, alternatively or additionally, certain keypoint measurements in order to increase mesh accuracy and/or precision, though it is contemplated that this will not be necessary to practice the invention.

In some embodiments, the system may be operative to generate a 3D mesh of a human target using Human Mesh Recovery (“HMR”) neural networks, known to those of ordinary skill in the art. More particularly, HMR neural networks are pretrained on certain large datasets containing many tens of thousands of images of humans, which improves their accuracy. That is, the system may be configured to extract 3D meshes by neural methods and further configured to render 3D human figures and shapes from 2D monocular images and/or input video. Indeed, it is contemplated that this will allow the system to continually display a three-dimensional mesh of a target in real time, even while such target is in motion.

In light of the foregoing, it is contemplated that the system may be operative to recognize human or even animal features, bodies, or body parts as amongst other inanimate aspects included in a targeted scene and subsequently generate a 3D mesh of such features, bodies, or body parts.

Likewise, the system may be operative to receive and/or generate 3D meshes of apparel and accessories, accurate to their real-world size and dimensions as well. In an embodiment, the system may be operative to display the 3D apparel and accessories in conjunction with a targeted individual, body, or body part. It will be recognized that certain features on apparel and accessories may correspond to keypoints on the human body and may therefore enable the system to directly apply the rendered apparel or accessory as if it is being worn. As an example, a three-dimensionally represented jacket can be placed on the 3D mesh ofa targeted torso, as if the targeted torso were wearing the jacket. In the event that the target is in motion and the system is displaying a 3D mesh of the target in real time, the system may be operative to display the jacket, or other apparel or accessory, on the target in motion as well.

It is contemplated that any apparel and accessories may be rendered in 3D according to their real-world size. Thus, any apparel and accessories may be represented according to their true size relative to the true size targeted individual, animal, or body part it is contemplated that this will enable a target to “try-on” or review the relative sizing and appearance of apparel and accessories on his own body without any need of physically accessingr or handling the apparel and accessories. Indeed, in some embodiments, a retailer may provide 3D renderings of any or all apparel, apparel, shoes, handbags, sunglasses, jewelry, and other clothing and accessories that they offer for sale, in various sizes, or the means to render their inventory in 3D. Means for rendering inventory in 3D may include, for example, a series of photos showing multiple perspective and plan views of any apparel or accessory and, in some cases, even certain keypoint measurements.

In some embodiments, the system may be configured to display apparel and accessory inventory to a user of the system. In the interest of clarity, inventory may refer to any digitally represented goods which are capable of augmenting a user's appearance. In some embodiments, inventory correlates to real-world goods available for purchase. In some embodiments, inventory simply refers to a body of digital apparel, or garments, and accessories which may be digitally applied to a 3D mesh of a target to appear as if being “worn” by the target. In any case, the system may be configured to filter the inventory based on user interest and. selections. In some embodiments, the system may be configured to automatically filter the inventory based on the size of the target. In some embodiments, and in particular in those embodiments in which inventory correlates to actual goods available for purchase, the system may be configured to automatically filter the inventory based on availability.

As such, it will be recognized that elements comprising the system may be operative or otherwise configured to matching limited inventories correlated to real-world inventories and dynamically update such inventories based on the size of a target as determined by the methods comprising the invention. Providing a system in this manner enables potential retail customers, for example, to virtually view and try on actual inventory narrowed to the subject's specification and measurements determined by the system. It is also contemplated, however, that the system may enable augmentation for social purposes as well. That is, in some embodiments, such as those occurring in augmented and virtual reality social networks, a target, such as a user of the system, may be seen by other users in such networks to be wearing virtual goods that have been photo-realistically, three-dimensionally rendered relative to the target's own size as determined by the depth scanner or other means and apparently applied to the target's body as it would appear in the real world.

Thus, in light of the foregoing, the system, method, and apparatus augment reality with digital renderings of merchandise listings, and, more generally, apparel and accessories.

It is an object of the invention to enables a user to shop for relevant merchandise listings from any remote location using a personal electronic device such as a smartphone, laptop, or even tablet computer.

It is another object of the invention to augment the appearance of a targeted individual or body part with clothing and accessories nrt a manner that accurately represents the relative size of each of the individual or body part and clothing and accessories in three dimensions.

It is an object of the invention to ease purchasing decisions based on size.

It is also object of the invention to ease purchasing decisions based on aesthetics.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a block diagram of a networked environment in which an exemplary embodiment of a system for augmenting reality with true-to-size apparel is implemented.

FIG. 2 shows a flowchart depicting an exemplary embodiment of a method for augmenting reality with true-to-size apparel.

FIG. 3 illustrates an exemplary embodiment of a smartphone shown in FIG. 1.

FIG. 4 illustrates an exemplary user interface in accordance with one embodiment of the invention.

FIGS. 5A and 5B show alternative exemplary user interfaces in accordance with one embodiment of the invention.

FIG. 6 shows another exemplary user interface in accordance with one embodiment of the invention.

FIG. 7 shows yet another alternative exemplary user interface in accordance with one embodiment of the invention.

FIGS. 8A and 8B show alternative exemplary digitally augmented bodies in accordance with one embodiment of the invention.

FIGS. 9A and 9B show other alternative exemplary digitally augmented bodies in accordance with one embodiment of the invention.

The disclosed embodiments may be better understood by referring to the figures in the attached drawings, as provided below. The attached figures are provided as on-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A system, method, and apparatus for augmenting reality with true-to-size apparel and even accessories is provided. Such system, method, and apparatus may be performed by or at a personal electronic device such as a smartphone.

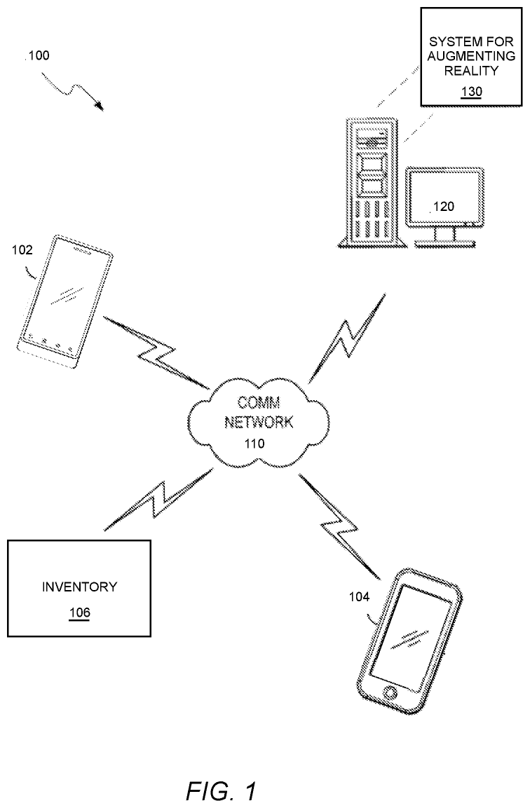

FIG. 1 is illustrative of a networked environment in which an exemplary embodiment of a system for augmenting reality is implemented. As shown in FIG. 1, system 100 comprises a personal electronic device such as a smartphone 102. The smartphone 102 may be embodied as a mobile computing device such as, for example and without limitation, a smartphone that incorporates cellular telephone and internet functionality capable of connecting to others on via a communications network 104 that use one or more of various communications types such as, for example and without limitation, cellular and Wi-Fi communications.

A user of the smartphone 102, 104 may use their device to capture still images, videos and even display a real-world scene in real time by way of integrated or auxiliary camera functionality.

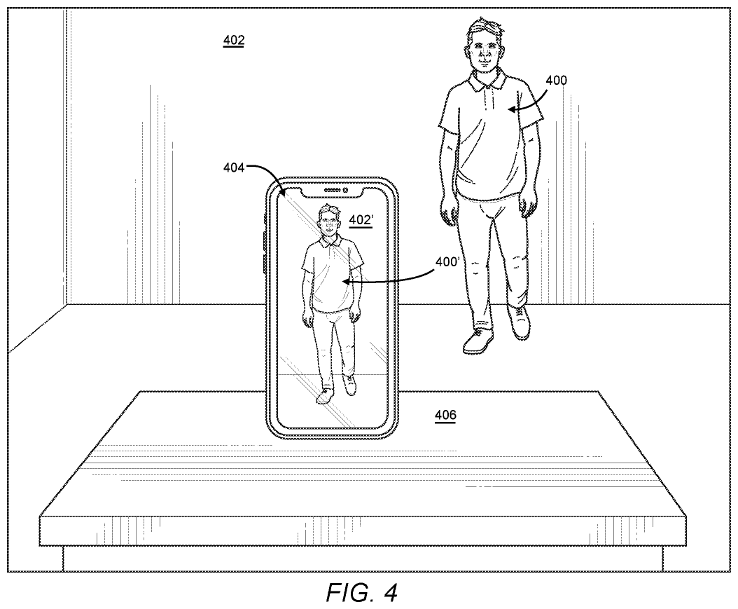

Additionally, a user of the smartphone 102 may user their device to access mobile software applications and websites, such as those relating to retail shopping, gaming, and social networking. In an embodiment, the smartphone 102 may enable users to become members of a social network (not pictured) that enables them to interact with each other using their smartphones 102 and 104 and exchange messages, photos, and live and recorded videos with one another. In an embodiment, such software applications and websites may be hosted by a server 120. As such, server 120 may facilitate interaction among, for instance, members of the social network, shoppers and retailers, and others. For the purpose of the example presented in FIG. 4, the limited group of members includes the users of smartphones 102 and 103.

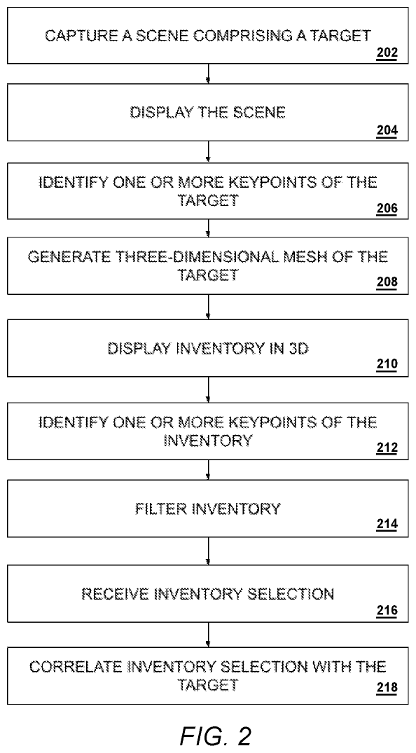

Additionally, server 120 implements the system for augmenting reality and facilitates three-dimensional rendering of targeted bodies or body parts as well as the receipt, filtration, and display of inventory in correlation with such three-dimensionally rendered bodies. Specifically, the server 120 implements the steps outlined in FIG. 2, enabling a user can access the server 120 using their smartphones 102 and 103 in order to digitally “try on” or “wear” inventory including clothing and accessories, which will be displayed on their smartphones 102, 103, as well as socially engage such three-dimensionally augmented figures with others.

In order to facilitate the aforementioned functionality, various aspects may be performed by one or more of the smartphones 102, 103. More particularly, FIG. 2 is a flowchart depicting, an exemplary embodiment of a system and method for the system for augmenting reality such as may be performed by smartphone 102 and 103 of FIG. 1. As shown in FIG. 1, the method includes the following steps: capturing a scene comprising a target (block 202) where the target comprises at least one body or body part; displaying the scene (block 204); identifying on or more keypoints of the target (block 206) which may be features or aspects of the body such as an outline or outer surface of the target, any joints such as shoulders, elbows, knees, wrists, ankles, and hips, and other recognizable features or landmarks; generating a three-dimensional mesh of the target (block 208) accurately sized relative to any other objects in the scene, displaying inventory in three-dimensions (block 210), where inventory comprises digitally rendered items of clothing and accessories which may or may not represent physical clothing and accessories available to purchase in the real-world; identifying keypoints of the inventory (block 212); filtering inventory (block 214); receiving an inventory selection (block 216); and correlating inventory selection with the target (block 218), which may be according to the keypoints.

With respect to operation of system fir augmenting reality 130, the system 130 itself may be operative to perform, at least in part, the method depicted in the flowchart of FIG. 2.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the sniartphone 102, 103. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

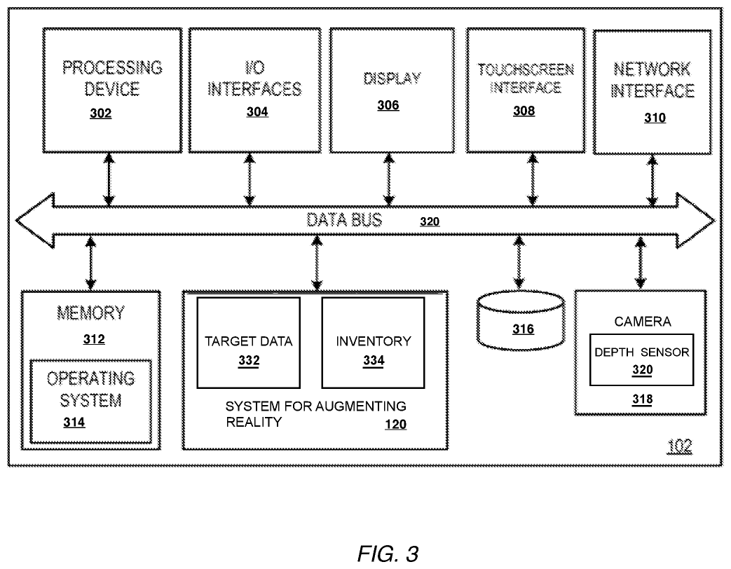

FIG. 3 illustrates smartphone 102 shown in FIG. 1. As described earlier, smartphone 102 is presented as a nonlimiting example of the type of personal electronic device as may be configured to implement the methods described herein. In some embodiments, the personal electronic device may be a tablet, desktop, or laptop computer but may also be embodied in any one of a wide variety of wired and/or wireless computing devices. As shown in FIG. 3, smartphone 102 includes a processing device (processor) 302, input/output interfaces 304, a display 306, a touehscreen interface 308, a network interface 310, a memory 312, and operating system 314, a mass storage 316 and a camera 318, with each communicating across a local data bus 320. In this example, the camera 318 is shown fully integrated in the smartphone and further comprises a fully integrated depth sensor 320, such as a LiDAR sensor. However, it is contemplated that either or both of the camera and depth sensor may be auxiliary units in wired or wireless communication with the smartphone 102 or other personal electronic device. Additionally, smartphone 102 incorporates a system for augmenting reality 100, which is depicted as including target data 332, such as recorded photos and real-time or recorded videos comprising 3D meshes, and inventory 334, which may comprise any of the various apparel and accessories as may be rendered or received and displayed in 3D and correlated to the target, although the location of information 332, 334 could vary.

The processing device 302 may include any custom made or commercially available processor, a central processing unit (CPU) or an auxiliary processor among several processors associated with the smartphone 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the smartphone 102. In accordance with such embodiments, the components are stored in memory and executed by the processing device. Note that although depicted separately in FIG. 3, the system and method for augmenting reality 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the smartphone 102 will comprise GPS (not pictured) or other means to determine the location of the smartphone 102.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

The method of FIG. 2 may be clarified with reference to exemplary embodiments of a user interface. With reference to FIG. 4 an exemplary personal electronic device having an integrated camera is provided as a smartphone 404. In one embodiment, such smartphone 404 may be operative to capture a scene 402 which comprises at least a portion of a body, such as the exemplary human 400 subject or another target of the camera. This may be shown on a display screen 404 as the targeted scene 402′ shown in the figure. It will be seen that the entire human 400′ is displayed as the target within the camera's display screen 404. It will be recognized that either or both of the display screen 404 and camera (not individually shown) may be integrated with the personal electronic device or auxiliary to it. That is, the system may comprise an external visual monitor or display screen in communication with the camera and personal electronic device without departing from the invention. While the device is shown in the figure as being supported on a surface 406, it is contemplated that a photographer other than the target of the Photo may utilize the smartphone to capture the scene and/or target. In some instances, the target them self may remotely cause the smartphone or other device to capture the scene by some means for activating or engaging the camera. In still other instances, the smartphone or other device may be configured to capture and display a scene comprising a “selfie” comprising a portion of the photographer them self, which is known to those of ordinary skill in the art.

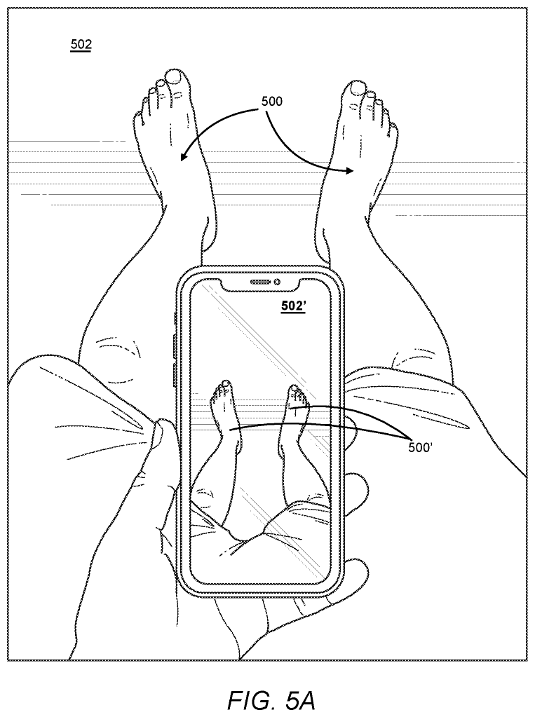

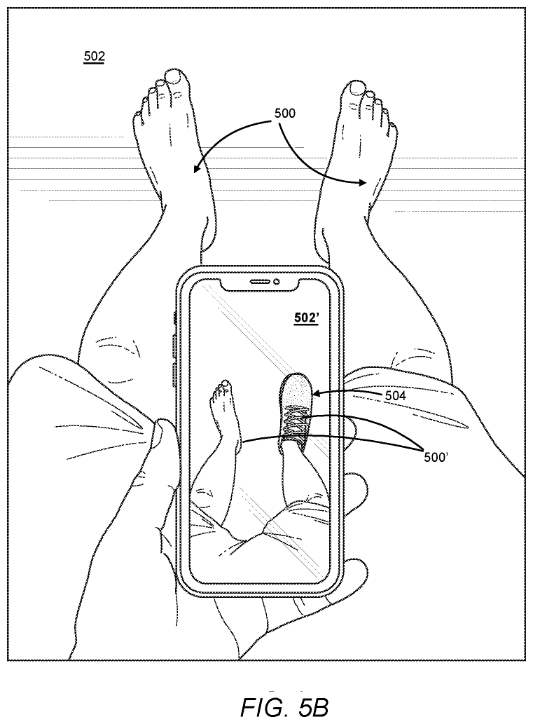

For instance, in FIG. 5A, it may be seen that a targeted scene 502 may comprise only portions of a body such as limbs, appendages, and other features. In this case, the target comprises a smartphone user's feet 500, which appear on the smartphone display screen 504 in the targeted scene 502′ as 500′. That is, the displayed targeted scene 502′ may comprise portions of the smartphone user them self, though, as above, it is not necessary for the target or subject of the photo to engage the system in order to practice the invention.

Turning to FIG. 5A, one manner in which the system is configured to augment reality with true-to-size apparel is provided. Namely, it may be seen that while one foot 500 in the targeted scene 502 appears in the displayed scene 502′ augmented with a digitally rendered shoe 504. Such shoe, or any other apparel or accessory, may be digitally rendered such that its size relative to the target, here a user's foot, appears accurate to the real-life relative size of target and apparel or accessory. It is contemplated that this will enable users of the system to accurately assess aspects of apparel and accessories prior to making real-world purchases of physical goods each digital rendering may represent. To that end, the system may be configured such that any augmentation tracks the target of the camera. For example, should the target move within the targeted scene 502′ shown on the display screen, it is contemplated that the shoe 504, for example only and not limitation, will move as well and according to the movement of the target. Indeed, digitally rendered inventory may be configured to appear to bend and turn in three dimensions as they would if worn in the real world, and, likewise, the system may be operative to display life-like shading and shadows to the as desired.

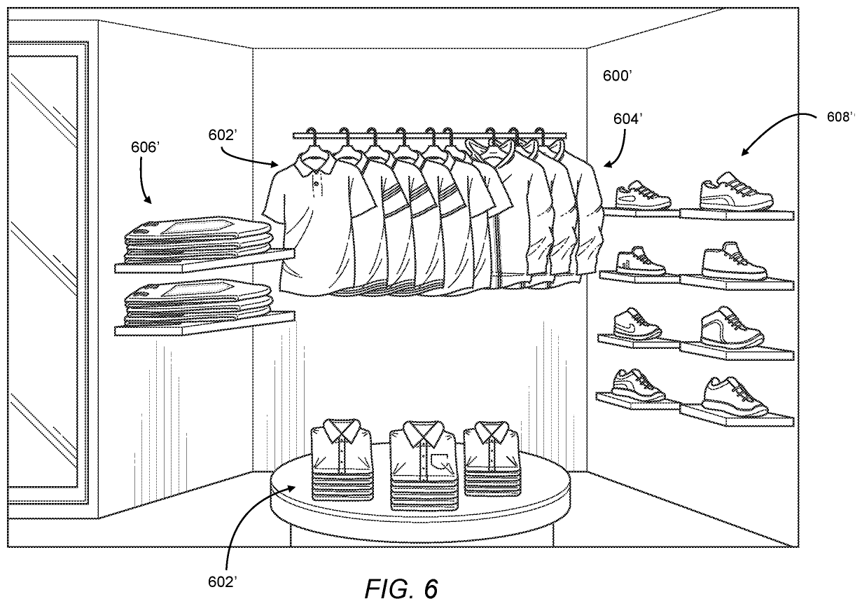

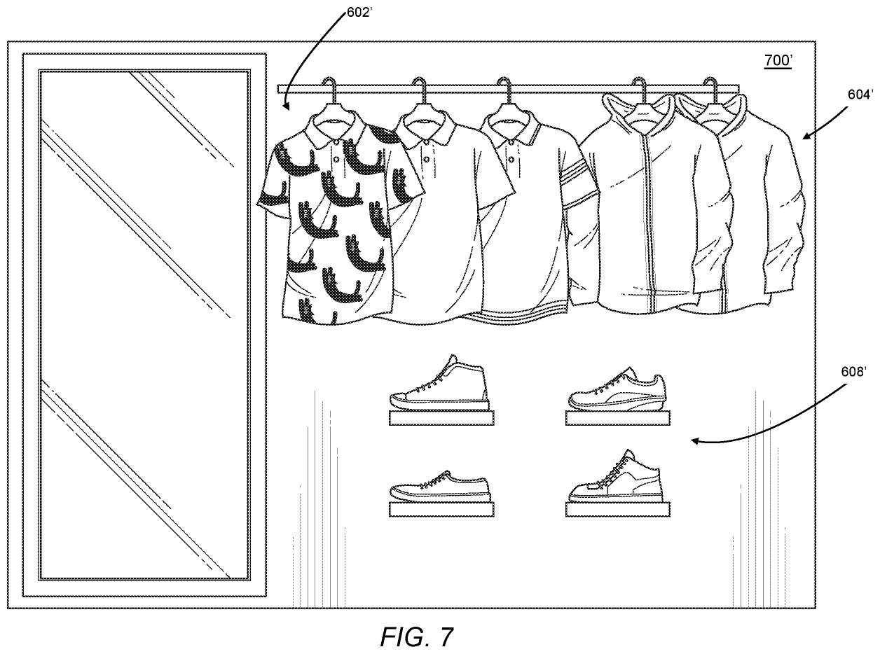

It is further contemplated that the system may be configured to display relevant inventory for selection by a user. FIGS. 6 and 7 illustrate alternative embodiments of inventory displays. For instance, per FIG. 6, a smartphone display screen may show a digital rendering 600′ comprising garments as shirts 602′, sweaters 604′, and pants 606′ as well as accessories as shoes 608′ available for selection by a user. In some embodiments, the rendering 600′ may appear to augment a real-world targeted scene in which the target appears similarly to the digital augmentation of a user's foot with the shoe shown in FIG. 5B. That is, it is contemplated that the real-world surroundings of a target appearing in a targeted scene may comprise digital renderings such as the inventory as arranged in FIG. 6. This means that in some embodiments, digital inventory may appear to a user as it might in a physical store, though this is not necessary to practice the invention and can be displayed by the system to the user in countless ways. For instance, inventory may appear to simply float unsupported against a targeted scene. Thus, it will be recognized that the manner of display will not inhibit the invention.

Turning to FIG. 7, In some embodiments, the inventory shown may be filtered from a larger collection. For instance, the inventory may be filtered to account for the target's size, a retailer's real-world inventory, and even artificial restrictions of non-fungible digital goods to manufacture scarcity amongst users. Filtering may occur automatically or by request of the user or a third-party.

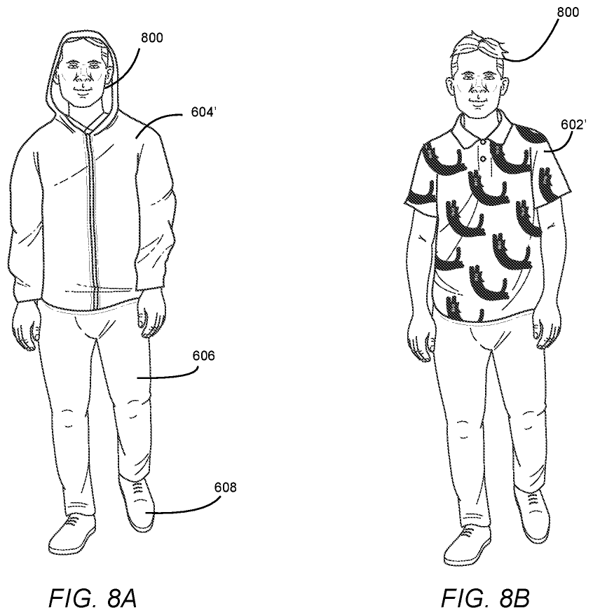

With reference to FIG. 8A, the system may be configured to receive a selection for some digitally rendered inventory, and then accurately apply such inventory to the 3D mesh of a target. In the instant example, a digitally rendered sweater 604′ from FIG. 7 appears to be worn by the target. As noted previously, the inventory may be rendered to reflect its size relative to the size of the target. Digitally rendered inventory may be displayed in conjunction with real world aspects of the target and scene. For instance. In FIG. 8A, the target's pants 606 and shoes 608 displayed may be those worn in real life by the target and therefore appear un-augmented in the displayed scene. Any background or additional material in the targeted scene may be virtual or real as desired.

In FIG. 8B, it may be seen that the sweater 604′ of FIG. 8A has been replaced with a shirt 602′ to visually alter the target's 800 augmented appearance.

In some embodiments, keypoints assigned or extracted from the target and inventory may be correlated to ensure that digital augmentation of a target's body or body part or feature appears accurate to real life. For example, a digitally rendered sweater with “shoulders,” “wrists” and even a neck opening will correspond to such keypoints on a target.

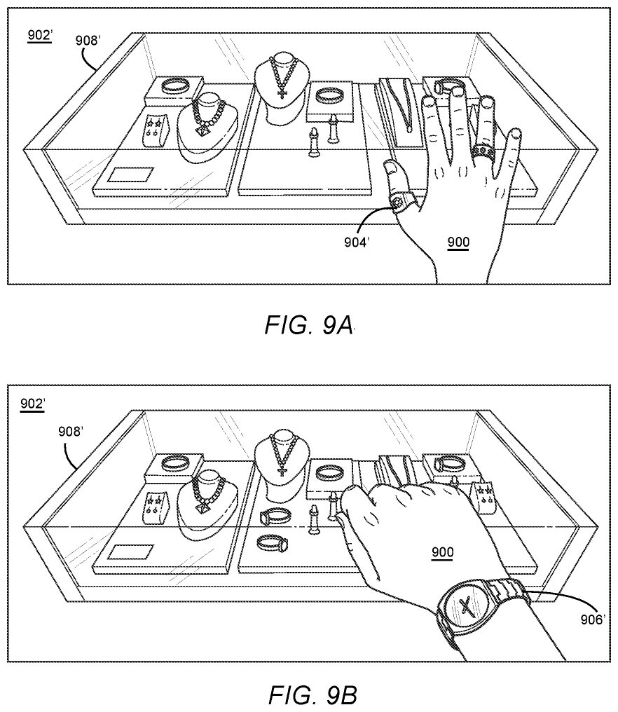

Turning to FIGS. 9A and 9B, it should be noted that any and all of the foregoing will apply to accessories. That is, a target may comprise a hand 900 which may be augmented with rings 904′ or a wrist watch 906′ or another accessory or accessories' as desired. The targeted scene 902′ may be augmented with inventory comprising a jewelry display case 908′ such as any one might find in a real-world retail store, or any other means of displaying inventory, and jewelry and other accessories may be filtered automatically or upon request according to the target's size, real world availability, and even aesthetic tastes and interests.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, any type of digitally rendered augmentation to a figure, individual, body part, or other subject in a scene may be sufficient by the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, we incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method and apparatus for augmenting reality with true-to-size apparel with which that terminology is associated. In general, the terms used in the following claims should not be constructed to limit the system, method and apparatus for augmenting reality with true-to-size apparel to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for augmenting reality with true-to-size apparel is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for augmenting reality with true-to-size apparel.

What is claimed is:

1. A system for augmenting reality with true-to-size apparel, comprising:
a personal electronic device operative to:
capture and display a scene on the electronic device, the scene containing at least a portion of a body part;
identify a plurality of keypoints on the body part;
generate a three-dimensional mesh of the body part;
receive one or more three-dimensionally rendered articles of clothing and accessories;
identity a plurality of keypoints on the one or more articles of clothing and accessories;
receive a selection of the one or more articles of clothing and accessories;
correlate the keypoints on the body part with the keypoints on the one or more articles of clothing and accessories; and
track any movements of the one or more articles of clothing with any movements of the body part.

2. The system of claim 1, wherein the scene is captured and displayed in real time.

3. The system of claim 1, wherein the articles of clothing and accessories correspond to physical goods available for purchase in the real-world.

4. The system of claim 1, wherein the personal electronic device is further operative to filter the one or more articles of clothing and accessories according to the type of the body part and relative size of the body part.

5. A method for augmenting reality with true-to-size apparel, comprising:
by a personal electronic device,
capturing a scene comprising a target;
displaying the scene comprising the target;
identifying one or more keypoints of the target
generating a three-dimensional mesh of the target;
receiving inventory;
displaying inventory in three-dimensions;
identifying one or more keypoints of the displayed inventory;
filtering the inventory;
receiving an inventory selection; and
correlating the inventory selection with the target according to the target and selected inventory keypoints.

6. The method of claim 5, wherein the target comprises at least a portion of one or more human or animal bodies or body parts.

7. The method of claim 1, wherein the one or more keypoints are selected from the group consisting of surface outlines, terminal points, joints, facial features, and appendages.

8. The method of claim 5, wherein filtering the inventory occurs according to the relative size of the target as compared to the size of the inventory.

9. A non-transitory, tangible computer-readable medium haying stored thereon computer-executable instructions, which, when executed by a computer processor, enable performance of a method comprising:
by a personal electronic device,
capturing and displaying a scene on the electronic device, the scene containing at least a portion of a body part;
identifying a plurality of keypoirits on the body part;
generating a three-dimensional mesh of the body part;
receiving one or more three-dimensionally rendered articles of clothing and accessories;
identifying a plurality of keypoints on the one or more articles of clothing and accessories;
receiving a selection of the one or more articles of clothing and accessories;
correlating the keypoints on the body part with the keypoints on the one or more articles of clothing and accessories; and
tracking any movements of the one or more articles of clothing with any movements of the body part.

10. The system of claim 9, wherein the capturing and displaying step occur in real time.

11. The system of claim 9, wherein the articles of clothing and accessories correspond to physical goods available for purchase in the real-world.

12. The system of claim 9, wherein the method further comprises filtering the one car more articles of clothing and accessories according to the type of the hod part and relative size of the body part.
